(19) United States
(12) Patent Application Publication
(10) Pub. No.: US 2014/0244500 A1
(43) Pub. Date: Aug. 28, 2014

(54) Intermodal money transport system and method for real-time cash or cash equivalent transfers on electronic devices with an intermodal money application interface that functions as an automated teller machine over one or more open loop financial networks by utilizing a virtual account management system and an intermodal money transport protocol

(71) Applicant: Aurelio Elias, Hurst, TX (US)

(72) Inventor: Aurelio Elias, Hurst, TX (US)

(21) Appl. No.: 14/176,130

(22) Filed: Feb. 9, 2014

Related U.S. Application Data
(63) Continuation of application No. 13/539,386, filed on Jun. 30, 2012.

(51) Int. Cl. G06Q 20/06; G06Q 20/10

(52) U.S. Cl. CPC G06Q 20/065; G06Q 20/1085
USPC 705/43

(57) ABSTRACT

Disclosed is an intermodal money transportation system and method to send and receive money in real-time on a computer programmable electronic device with an ATM application interface over open loop financial networks during a single financial transaction acquiring session, utilizing an intermodal money transportation protocol data set that is compatible with financial network message protocols, and a virtual account management system that enables financial instrument holders to convert a plurality of financial instruments into virtual cash tokens in a manner that is independent of the modality of payment method used to process said financial instruments, where said financial instruments are readily convertible into cash or a cash equivalent on a transaction terminal and the transaction is irreversible by the originator of said transaction.

This application is a continuation-in-part of Non Provisional patent application Ser. No. 13/539,386 filed Jun. 30, 2012 and Ser. No. 13/762,335 filed Feb. 7, 2013 by the present inventor, which is incorporated by reference.

### PRIOR ART

The following is a tabulation of some prior art that presently appears relevant:

United States Patents

| Pat. No. | Issue Date | Patentee |
|---|---|---|
| 3,826,344 | July 1974 | Wahlbgerg |
| 4,114,027 | September 1978 | Slater et al. |
| 4,305,059 | December 1981 | Benton |
| 4,319,336 | March 1982 | Anderson et al. |
| 4,321,672 | March 1982 | Braun et al. |
| 4,341,951 | July 1982 | Benton |
| 4,498,000 | February 1985 | Decavele et al. |
| 4,529,870 | July 1985 | Chaum |
| 4,707,592 | November 1987 | Ware |
| 4,766,293 | August 1988 | Boston |
| 4,773,001 | September 1988 | Blair et al. |
| 4,823,264 | April 1989 | Deming |
| 4,926,368 | May 1990 | Morita et al. |
| 5,012,076 | April 1991 | Yoshida |
| 5,025,373 | June 1991 | Keyser, Jr. et al. |
| 5,157,717 | October 1992 | Hitchcock |
| 5,162,783 | November 1992 | Moreno |
| 5,184,115 | February 1993 | Black et al. |
| 5,220,501 | June 1993 | Lawler et al. |
| 5,231,662 | July 1993 | Van Rumpt et al. |
| 5,255,305 | October 1993 | Sattar |
| 5,326,960 | July 1994 | Tannenbaum |
| 5,336,870 | August 1994 | Hughes et al. |
| 5,337,358 | August 1994 | Axelrod et al. |
| 5,350,906 | September 1994 | Brody et al. |
| 5,367,561 | November 1994 | Adler et al. |
| 5,376,948 | December 1994 | Roberts |
| 5,420,926 | May 1995 | Low et al. |
| 5,424,938 | June 1995 | Wagner et al. |
| 5,440,634 | August 1995 | Jones et al. |
| 5,448,043 | September 1995 | Nakano et al. |
| 5,455,407 | October 1995 | Rosen |
| 5,457,305 | October 1995 | Akel et al. |
| 5,465,206 | November 1995 | Hilt et al. |
| 5,483,261 | January 1996 | Yasutake |
| 5,524,073 | June 1996 | Stambler |
| 5,544,086 | August 1996 | Davis et al. |
| 5,546,523 | August 1996 | Gatto |
| 5,550,358 | August 1996 | Tait et al. |
| 5,564,974 | October 1996 | Mazur et al. |
| 5,570,113 | October 1996 | Zetts |
| 5,590,196 | December 1996 | Moreau |
| 5,625,562 | April 1997 | Veeneman et al. |
| 5,650,604 | July 1997 | Marcous et al. |
| 5,659,165 | August 1997 | Jennings et al. |
| 5,661,781 | August 1997 | DeJager |
| 5,677,955 | October 1997 | Doggett et al. |
| 5,825,003 | October 1998 | Jennings et al. |
| 5,903,881 | May 1999 | Schrader et al. |
| 5,913,203 | June 1999 | Wong et al. |
| 5,915,023 | June 1999 | Bernstein |
| 5,937,396 | August 1999 | Konya |
| 5,963,647 | October 1999 | Downing et al. |
| 6,000,608 | December 1999 | Dorf |
| 6,081,792 | June 2000 | Cucinotta et al. |
| 6,142,369 | November 2000 | Jonstromer |
| 6,173,269 | January 2001 | Soloki et al. |
| 6,488,203 | December 2002 | Stoutenburg et al. |
| 7,024,174 | July 2002 | Nagy, et al. |
| 6,505,178 | January 2003 | Flenley |
| 6,736,314 | May 2004 | Cooper et al. |
| 6,796,492 | September 2004 | Gatto |
| 8,494,934 | June 2006 | Atkinson, et al. |
| 7,096,003 | August 2006 | Joao et al. |
| 7,155,411 | December 2006 | Blinn, et al. |
| 7,376,587 | May 2008 | Neofytides et al. |
| 7,182,252 | February 2007 | Cooper, et al. |
| 7,195,151 | March 2007 | Licciardello, et al. |
| 7,363,265 | April 2008 | Horgan |
| 7,415,442 | August 2008 | Battaglini, et al. |
| 7,416,115 | August 2008 | Licciadello, et al. |
| 7,512,254 | March 2009 | Vollkommer, et al. |
| 7,529,710 | May 2009 | Clower, et al. |
| 7,580,898 | August 2009 | Brown, et al. |
| 7,627,524 | December 2009 | Bennett, et al. |
| 7,644,037 | January 2010 | Battaglini, et al. |
| 7,664,703 | February 2010 | Hansen, et al. |
| 7,665,657 | February 2010 | Huh |
| 7,693,790 | April 2010 | Lawlor, et al. |
| 7,708,199 | May 2010 | Gatto |
| 7,720,754 | May 2010 | Gutierrez-Sheris |
| 7,780,075 | August 2010 | Cooper, et al. |
| 7,792,748 | September 2010 | Ebersole, et al. |
| 7,801,799 | September 2010 | Brake, Jr., et al. |
| 7,802,718 | September 2010 | Barcelou |
| 7,822,684 | October 2010 | Rielly, et al |
| 8,572,377 | April 2011 | Kalbratt |
| 7,946,480 | May 2011 | Miller, et al. |
| 8,266,058 | September 2012 | Anderson |
| 8,554,672 | Oct. 8, 2013 | Rizo, et al |
| 8,632,000 | June 2008 | Laracey |
| 2002/0013711 | January 2002 | Ahuja et al. |

### BACKGROUND

Although numerous patents exist, including those listed above that presently appear relevant, the present embodiment of the system and method is novel and substantially different in a plurality of elements, thus rendering the embodiment unobvious to a person skilled in the art. However, it is recognized that there is a significant body of prior art in the fields of electronic money transfers, electronic payments and financial accounts, including but not limited to cards, virtual accounts, computer systems, automated teller machines, and other computing devices that utilize or access ‘open loop’ financial networks. The present embodiment describes a system and method that is superior to the prior art for a new and novel way to effect real-time value transfers on electronic devices (e.g. automated teller machines, point of sale systems, self-service kiosks, personal computers, mobile phones, etc.) over one or more open loop financial networks during a single financial transaction acquiring session by utilizing an intermodal money transportation data set and a virtual account management system which enable users to convert a plurality of financial instruments (e.g. cash, check, payment card, ACH, money order, cash voucher, E-coupon, virtual currency, etc.) into a ‘virtual cash token’ which is readily convertible into cash or a cash equivalent that is more universally useable and more versatile in operation.

The present embodiment of the system and method also provides for a new and useful way to enable an electronic device with an intermodal money application interface to function as automated teller machine (“ATM”) where the transactions are processed as ATM withdrawals and deposits or as any other transaction that can be performed on a self-service payment terminal that are not directly linked to one or more demand deposit accounts, payment cards or the like that are controlled by the sender as the originator of the transaction, over one or more open loop financial networks and processed by said virtual account management system. Moreover, the send and receive cash or cash equivalent transactions can be performed without requiring either the sender or the receiver to use payment card or bank account information by utilizing said virtual account management system to create a virtual account number comprising; an issuer identification number (“IIN”) and a unique identifier, such as mobile telephone number, a purchase order number, or a voucher number belonging to the originator (“Sender”) or the beneficiary (“Receiver”) of said ATM withdrawals and deposits.

Furthermore, an electronic device with said intermodal money application interface utilizing an intermodal money transportation data set (“Intermodal Money Transport Protocol”) comprising; said virtual account number and an encrypted personal identification number (“PIN”) generated by said virtual account management system, with said electronic device connected to one or more open loop financial networks utilizing a virtual cash token comprising; said virtual account number, said PIN, the transaction amount, and a combination of Sender and Receiver personal and financial service information to perform ATM withdrawals and deposits or any other transaction that can be performed on a self-service payment terminal through said virtual account management system and provide timely notification to both Sender and Receiver via electronic medium that the funds have been transferred and readily available in cash or a cash equivalent. Another advantage of the embodiment of the present invention is a promotional offer of cash or cash equivalent may be transmitted to said Receiver and/or Sender at the time of said notification.

The present embodiment of the invention is related to systems, methods, processes, computer program code, and means for using an electronic device with the intermodal money application interface (hereinafter referred to as “Transaction Terminal”) such as a mobile phone to conduct transactions with a plurality of payment terminals and cash dispensing devices such as ATMs and the like, that also have the intermodal money application interfaces. Unlike any other known prior art apparatus, this novel feature enables Transaction Terminal screen advertisements and promotions to offer cash back incentives and/or a ‘Call for Action’ redeemable ‘E-Coupon’ by prompting the user to send a request to the account management system utilizing a ‘Short Message Code’ displayed on the screen and/or printed on the Transaction Terminal receipt, and receive on the mobile device a unique virtual cash token that can be either immediately redeemed or saved in the memory of a said mobile device and redeemed at a later time on the same Transaction Terminal or on a different Transaction Terminal at another location connected to one or more open loop networks.

Another advantage of the present embodiment of the invention and other possible embodiments, is where a mobile device configured using features of the present embodiment may be capable of initiating transactions on a plurality of payment terminals and cash dispensing devices such as ATMs and the like without said intermodal money interface application, including ATM cash withdrawals or any other transaction that can be performed on a self-service payment terminal, that is delivered through a mobile device in the form of an SMS text message or in another form of electronic online medium displayed on a mobile device screen, where said mobile device receives a virtual cash token that is used in conjunction with an ‘instant issued’ or ‘pre-issued’ card that enable the payment terminals to route the transaction through one or more open loop financial networks to said virtual account management system for authorization.

In another embodiment of the present invention a Transaction Terminal with the intermodal application Interface may display screen advertisements offering a ‘card-linked’ marketing program promotion, when a user initiates a transaction with a payment card by swiping or dipping said card on said Transaction Terminal which retains the ‘track two’ card data including among other data, the cardholder's name and card number, and displays the terms and conditions and the privacy policy and any other required disclosures of the said card-linked marketing program and prompting the cardholder to opt-in to said card-linked marketing program, and if said cardholder opts-in, prompting the cardholder to enter a mobile phone number to receive promotional offers for discounts, cash back incentives and/or ‘Call for Action’ redeemable ‘E-Coupons’ and the Transaction Terminal sends the stored card data and mobile phone number to the virtual account management system, which creates a virtual account for the cardholder for the purpose of offering card-linked marketing program promotions, and sends to the mobile device a unique virtual cash token that can be either immediately redeemed or saved in the memory of a said mobile device and redeemed at a later time on the same Transaction Terminal or on a different Transaction Terminal at another location connected to one or more open loop networks.

The afore description of the present embodiment of the systems and methods and other possible embodiments are accomplished without the need for said Transaction Terminals of the Sender and Receiver of said transactions, to be in proximity to one another, as the connectivity to one or more open loop networks enables non localized payments to be performed at any Transaction Terminal (e.g. ATM, POS, Kiosk, PC, Smartphone, etc.) that is connected to one or more open loop networks. Unlike any of the prior art apparatus where a payment terminal transaction code is presented to an account holder on a mobile device at a location of a particular transaction terminal, where there is interaction between the mobile device and payment terminal through a transaction processing system. Furthermore no specialized transaction system, such a mobile device with an online mobile wallet application, be it cloud based, memory chip enabled with NFC capability, or WAP online internet access to a website, that is controlled by a transaction management system needs to interact with a particular Transaction Terminal through said transaction management system during the transaction session.

Intermodal transportation methods are commonplace in present day transportation systems. The efficiencies of intermodal transport are achieved through the standardization of transportation movement processes involving more than one mode, in a manner that the transported objects are able to be carried by different modes of transport without being unpacked or affected in transit, and essentially arrive at their destination untouched. However, the methods employed in intermodal transportation systems have presently not been applied to electronic money movement because of the multiplicity of modes employed in processing a plurality of financial instruments, and because the convertibility of non-cash financial instruments into cash are subject to restrictions imposed by the modality of the payment method used in processing the transaction. The present embodiment of the systems and methods for real-time money transfers comprises an intermodal money transportation system that is independent of the modality of the payment method used in processing said financial instruments and provides a new and useful way to electronically transport value as cash or a cash equivalent over one or more open loop financial networks utilizing said Intermodal Money Transport Protocol.

In today's economic environment, individuals must conduct cash transactions ‘face-to-face’ and therefore non-localized payments and online financial transactions can only be performed via bankcards, bank issued paper or electronic (“ACH”) checks, or real time gross settlement (“RTGS”) wire transfers from demand deposit accounts (“DDA”), or through non-bank financial intermediaries utilizing ‘closed loop’ systems. In fact the only way to affect near-real-time payments on an electronic device is through depository institution DDA ‘account-to-account’ debit or credit transfers, or through non-bank financial intermediaries. Individuals using electronic devices are limited to transactions with card accounts issued by financial institutions or as an electronic check transaction (ACH) from a demand deposit account, with the exception of closed-loop prepaid cards, or money remittance payments through non-bank financial intermediaries.

Currently, financial instrument holders must utilize depository institutions or non-bank financial intermediaries when converting their non-cash financial instruments into cash or cash into non-cash financial instruments. It is a common practice to use depository institutions to deposit third party checks or to receive ACH deposits before the financial instrument can be converted into cash. It is also common practice to use depository institutions to transfer money for a multiplicity of reasons associated with making payments and transferring funds. However, the convertibility of a non-cash financial instrument into cash is subject to restrictions imposed by the modality of payment method used in processing the transaction of the financial instrument, and the holding periods set by the depository institution. The non-real-time nature of said transactions causes many financial instrument holders to use non-bank financial intermediary money services businesses (“MSB”) such as check cashers, money order providers, money transmitters, currency exchange houses, and cash payments aggregators to convert non-cash financial instruments into cash or cash into non-cash financial instruments.

Presently there is no system or method to enable an individual to send and receive funds that are readily convertible to cash in real-time on an electronic device unless the device is a payment terminal that is controlled by the bankcard issuing financial institution or a non-bank intermediary financial service provider. This holds true for retail merchant based cash transactions on a point of sale (“POS”) system; where the merchant accepts a cash payment on behalf of a non-bank financial intermediary. Examples of such transactions include payment of bills, prepaid card loads, cash vouchers, and money transfers that are processed and settled through card issuing banks or third party payments aggregators. Typically third party aggregators that accept over-the-counter cash through merchant agent networks bypass the existing open loop financial networks and operate as closed loop financial networks. Although some cash payments aggregators do utilize open loop financial networks in providing bill payment services and prepaid card loads, none have a universal ‘pay-in’ and ‘pay-out’ solution through one or more open loop financial networks in a real-time cash or cash equivalent environment.

The afore mentioned limitations act as a barrier to interoperability between ATM and POS transaction networks and a multiplicity of financial service provider systems, because they must all be connected to the terminals in order for financial instrument holders to have access to said financial service provider systems. Furthermore, varying open loop financial network operating rules and regulatory compliance requirements make financial payment systems interoperability at the payment terminal level difficult and costly to implement, and participation in open loop financial networks is normally limited to depository institutions, therefore excluding non-bank financial service providers. The only automated real-time cash transactions presently available are via open loop financial networks connected payment terminals that are linked to bankcards issued by depository institutions or transaction terminals that are connected to closed loop financial networks.

In view of the limitations now present in the prior art, the present embodiment of the invention and other possible embodiments provide a new and useful system and method to transport funds that are readily convertible to cash or a cash equivalent in real-time over one or more open loop financial networks on a Transaction Terminal, comprising said virtual account management system and said Intermodal Money Transport Protocol where the value of the transaction is fixed at the point of origination and the authorized transaction is irreversible by the sender as the originator of the transaction, because the transaction is processed as an ATM cash transaction. The irreversibility of the transaction is assured by converting the financial instrument in real-time into virtual cash token deposit for the benefit of the receiver into a virtual account that is not controlled by the sender as the originator of the transaction and is not linked to one or more accounts controlled by the sender.

This new and novel system and method for money transfers in real-time that functions as an ATM transaction will work on all programmable electronic devices with said intermodal money application interface. Furthermore, programmable electronic devices with said intermodal money application interface including but not limited to POS terminals, online computers and mobile phones can act as functioning ATMs through a screen interface that requires only software modification to support a unique data set for connectivity to one or more open loop financial networks, where send and receive money transactions are processed as ATM withdrawals or deposits. Unlike near-real-time money transfer systems, this unique system requires no modification what-so-ever of the open loop financial network protocols and settlement procedures by the insertion of said Intermodal Money Transport Protocol data set.

The purpose of the present embodiment is to provide a new and improved system and method for authorizing and executing real-time cash or cash equivalent transfers utilizing open loop financial network systems (e.g. Transaction Processor, Transaction Terminal, Intermodal Money Application Interface, Interbank Settlement System, and Intermodal Money Transport Protocol) without requiring any modification of the existing ISO messaging protocols of said open loop financial networks or the Transaction Terminal transaction host processing system. The current state of the art does not provide this functionality at the ATM or POS payment terminal level nor at the financial network level.

The present embodiment of the system has many novel features not offered by the prior art apparatus that result in a new and much needed method for real-time money transfers utilizing said Intermodal Money Transport Protocol and said virtual account management system, which is simpler in construction, and is not apparent, obvious, or suggested, either directly or indirectly by any of the prior art apparatus, and more universally usable (utilizing open loop financial network systems) and more versatile in operation (enabling real-time cash or cash equivalent transfers on programmable electronic devices) than known apparatus of this kind

### ADVANTAGES

The present embodiment of the invention demonstrates a new and improved system and method for real-time cash or cash equivalent transfers over one or more open loop financial networks by utilizing the Virtual Account Management System (9) and Intermodal Money Transport Protocol (15), comprising:
1. An intermodal money transportation system enabling the execution of real-time transactions to send and receive cash or cash equivalent over open-loop financial networks for non-bank financial service providers.
2. Providing an Intermodal Money Transport Protocol (15) data set comprising, the Virtual Account Number (3) and Virtual Account Management System (9) generated encrypted personal identification number (“PIN”) to send and receive cash or a cash equivalent in real-time over open loop financial networks.
3. Enabling a Financial Instrument Holder (2) to convert non-cash financial instruments into cash or cash into non-cash financial instruments in a manner that is independent of the modality of payment method used in processing the transaction of the Financial Instrument (1).
4. Providing an intermodal money transportation system enabling the Financial Instrument (1) to be converted into cash or a cash equivalent in real-time where the transaction is not linked to a demand deposit account that is controlled by the sender as the originator of the transaction.
5. Providing an Intermodal Money Application Interface (8) enabling a programmable electronic device to act as a functioning ATM where send and receive funds transactions are processed as ATM cash withdrawals and deposits by the Open Loop Financial Network (7).
6. Enabling a programmable electronic device functioning as the Transaction Terminal (4) to send and receive cash or a cash equivalent in real-time over the Open Loop Financial Network (7) where the Virtual Account Management System (9) transmits the Virtual Cash Token (16) by electronic medium in the form of SMS text message, email, streaming media, interactive voice response, or the like to an electronic device (e.g. telephone, personal computer, mobile device, etc.) that is not functioning as a Transaction Terminal, including a Promotional Program (22) offer on said Transaction Terminal (4).
7. Enabling the Transaction Terminal (4) to display Promotional Screen Message (21) offering cash back incentives and/or a ‘Call for Action’ redeemable ‘E-Coupon’ by prompting the Financial Instrument Holder (2) to send a request to the Virtual Account Management System (9) utilizing a Mobile Code Message (24) such as a ‘Short Code’ displayed on the screen and/or printed on a Transaction Terminal receipt, where the Receiver and/or Sender of the transaction receive(s) a unique Virtual Cash Token (16) that can either be immediately redeemed or redeemed at a later time on the Transaction Terminal (4) or at a plurality of other Transaction Terminals (4) that are connected to one or more Open Loop Financial Networks (7).
8. Enabling the Transaction Terminal (4) with the Intermodal Money Application Interface (8) to display the Promotional Screen Message (21) offering a ‘card-linked’ marketing program promotion, when a user initiates a transaction with a payment card by swiping or dipping said card on said Transaction Terminal (4) where the cardholder is promoted to enter Promotional Program (22) information and sends the cardholder data to the Virtual Account Management System (9) that creates a virtual account that is linked to said card.
9. Enabling the Financial Instrument Holder (2) to send cash or a cash equivalent in real-time through the Transaction Terminal (4) where the Virtual Account Management System (9) transmits the Virtual Cash Token (16) by electronic medium to an electronic device that is not functioning as a “Transaction Terminal” where a cash or a cash equivalent can be received by a beneficiary as the owner of the Virtual Cash Token (16) at a multiplicity of other Transaction Terminals (4) that are connected to one or more Open Loop Financial Networks (7).
10. Providing a Virtual Cash Token (16) that is readily convertible into cash in real-time over one or more Open Loop Financial Networks (7) in a manner that comprises an intermodal money transportation system and method utilizing the Virtual Account Management System (9).
11. Enabling a non-cash Financial Instrument (1) to be converted into a Virtual Cash Token (16), on the Transaction Terminal (4), through the Virtual Account Management System (9), that is readily convertible into cash in real-time at a multiplicity of other Transaction Terminals (4) that are connected to one or more Open Loop Financial Networks (7).
12. Utilizing a Transaction Terminal (4), an Open Loop Financial Network (7), transaction processing systems, and third party financial services processing systems in a novel way to enable a holder of a financial instrument to send and receive cash or a cash equivalent in real-time.
13. Utilizing a combination of personal and financial sender and receiver information, virtual accounts for transaction auditing, virtual tokens for cash ‘electronification’, and a Virtual Account Number (3) for transaction validation and authorization, and depository settlement accounts for transaction settlement in sending and receiving money transfers that are readily convertible into cash or a cash equivalent in real-time on open loop financial network systems.
14. Enabling real-time validation of funds availability to insure clearing and settlement where the value of the transaction is fixed at the time of origination and providing assurance that a payment once received cannot be returned or reversed.
15. Providing timely notification to both the sender and receiver that the funds have been transferred and readily available in cash or a cash equivalent during a single transaction acquiring session on a Transaction Terminal (4).
16. Providing real-time access for a financial instrument holder to cash or a cash equivalent in a single session on a Transaction Terminal (4), through an Open Loop Financial Network (7).
17. Performing real-time funds transfer transactions without requiring either the sender or the receiver of said funds to disclose card or bank account information.

### DESCRIPTION OF THE FIRST EMBODIMENT

The first embodiment of the invention is a new and useful way for the execution of real-time cash or cash equivalent transactions over an Open Loop Financial Network (7) through a Transaction Terminal (4) utilizing a Virtual Account Management System (9), and a unique combination of Intermodal Money Transport Protocol (15) and financial network systems ISO message protocol management processes.

In view of the limitations now present in the prior art, the first embodiment of the system provides a new and useful method for offering an individual the ability to send and receive funds that are readily convertible to cash or a cash equivalent in real-time during a single financial transaction acquiring session on a Transaction Terminal (4), when the individual has selected a send or receive function on the Intermodal Money Application Interface (8), the Transaction Processor Acquirer (5) has validated the Transaction Request (13) and sends the transaction message through the Open Loop Financial Network (7), and the Virtual Account Management System (9) has validated the Virtual Cash Token (16), and the Transaction Processor Issuer (6) has authorized the transaction, and communicates the transaction details to the sender and receiver of said funds.

The first embodiment of the system relates generally to the field of apparatus and methods for real-time financial transactions that occur via the use of an individual's Financial Instrument (1), a Transaction Terminal (4) with the Intermodal Money Application Interface (8), an electronic funds transfer (“EFT”) Transaction Processor Acquirer (5) and Transaction Processor Issuer (6), and a provider of financial services. Moreover it pertains specifically to such apparatus for the management and execution of the automated financial transactions utilizing among other elements, the standard financial transaction messaging system and ISO message protocol, an aggregate of personal and financial services information, a Virtual Cash Token (16) to facilitate the transaction over existing financial network systems comprising an Intermodal Money Transport Protocol (15), Virtual Account Management System (9), Transaction Processor Acquirer (5), Transaction Processor Issuer (6), and Open Loop Financial Network (7) resulting in authorization and settlement of a cash or cash equivalent transaction in real-time that is irreversible by the sender as the originator of the transaction.

In the present embodiment of the invention a Transaction Terminal (4) with the Intermodal Money Application Interface (8) displays a Promotional Screen Message (21) offering a ‘card-linked’ Promotional Program (22), when a user initiates a transaction with a payment card by swiping or dipping said card on said Transaction Terminal (4) which retains the ‘track two’ card data including among other data, the cardholder's name and card number, and displays the terms and conditions and the privacy policy and any other required disclosures of the said Promotional Program (22) and prompting the cardholder to opt-in to said Promotional Program (22), and if said cardholder opts-in, prompting the cardholder to enter the Mobile Phone (19) number to receive promotional offers for discounts, cash back incentives and/or ‘Call for Action’ redeemable ‘E-Coupons’ and the Transaction Terminal (4) sends the stored card data and mobile phone number to the Virtual Account Management System (9), which creates a Virtual Account Number (3) for the cardholder for the purpose of offering card-linked marketing program promotions, and sends to the Mobile Phone (19) a unique Virtual Cash Token (16) that can be either immediately redeemed or saved in the memory of a said mobile device and redeemed at a later time on the same Transaction Terminal (4) or on a different Transaction Terminal (4) at another location connected to one or more Open Loop Financial Networks (7).

The foregoing has outlined, in general, the physical aspects of the first embodiment of the invention and is to serve as an aid for better understanding the more complete detailed description that is to follow. In reference to such, there is to be a clear understanding that the first embodiment of the invention is not limited to the method or detail of construction, fabrication, material, or application of use described and illustrated herein. Any other variation of fabrication, use, or application should be considered apparent as an alternative embodiment of the present invention.

A Financial Instrument Holder (2) initiates the transaction by entering the payment data comprising, the Virtual Account Number (3), PIN and the transaction amount into a Transaction Terminal (4) with the said Intermodal Money Application Interface (8), if the Financial Instrument Holder (2) is the sender additional payment data is provided (e.g. receiver information), the Transaction Processor Acquirer (5) validates the transaction and sends the Transaction Request (13) via the Open Loop Financial Network (7) to the Virtual Account Management System (9) which verifies the availability of the funds and either authorizes or denies the transaction; if the transaction is authorized by the Transaction Processor Issuer (6) the Financial Network settles the funds either directly to the acquirer settlement account or the beneficiary temporary virtual account, resulting in a real-time cash or cash equivalent payment that is irreversible by the sender as the originator of the transaction. Depending upon the state of art and implementation of this system, this transaction may happen in seconds.

To execute the above process requires understanding of: 1) a variety of transaction terminals, their design, specifications, distribution, use, managing software and communications protocols, 2) the processes of the existing financial transaction messaging transmissions and protocols, managing software and hardware, 3) interfaces to existing financial network systems and protocols, and 4) a method for the settlement of cash transactions. The system is described below.

### DRAWINGS

### Figures

The following drawings further describe by illustration the advantages and objects of the present invention. Each drawing is referenced by corresponding figure reference characters within the “DETAILED DESCRIPTION OF THE INVENTION” section to follow.

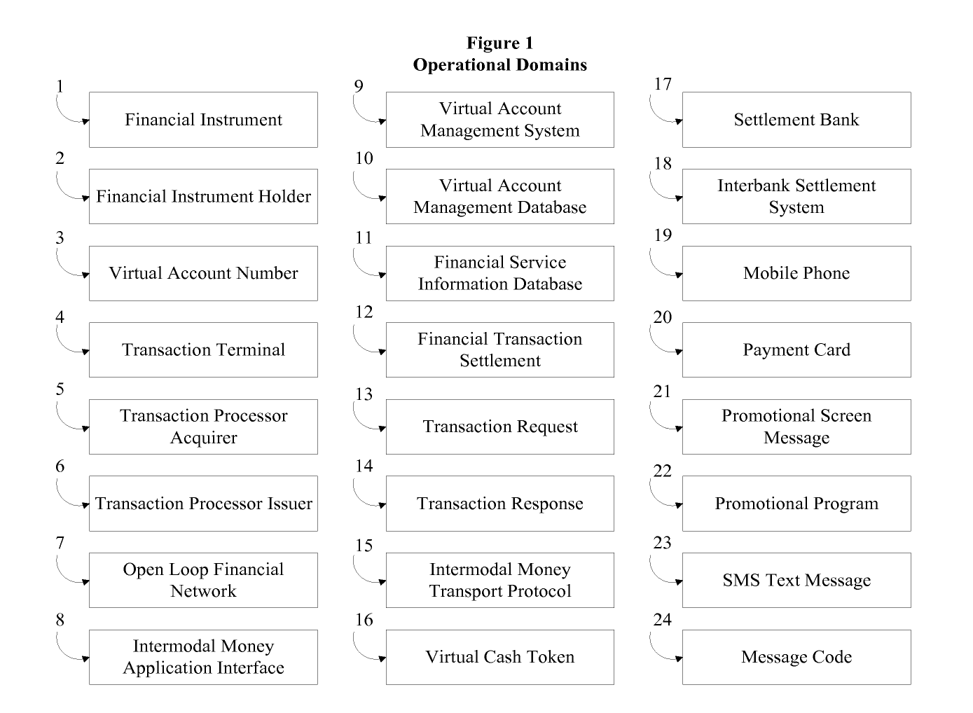

FIG. 1. Operational Domains utilized according to the present embodiment.

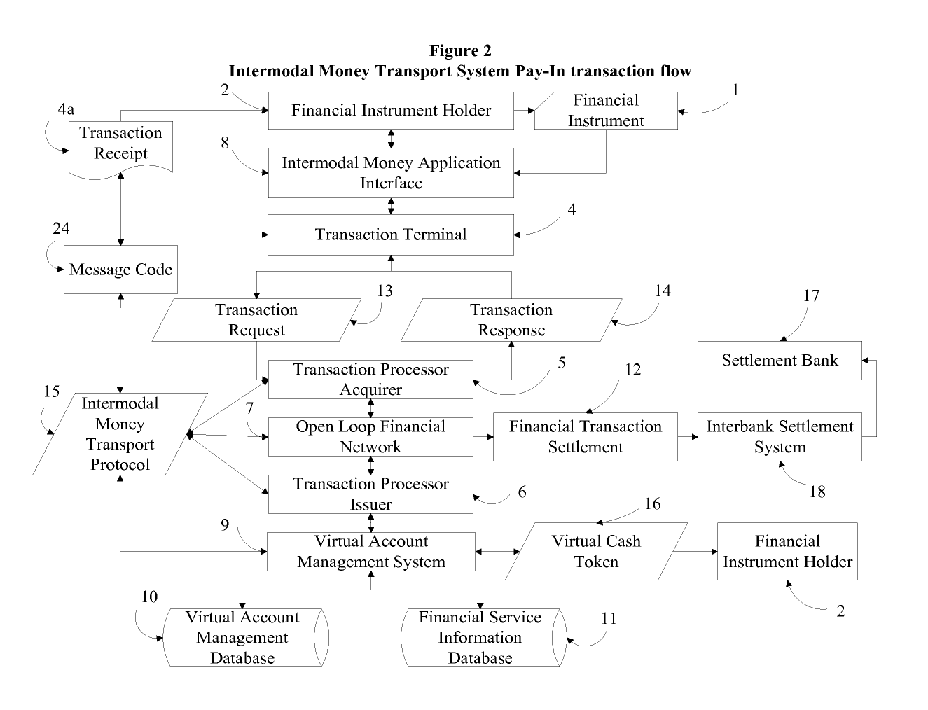

FIG. 2. Intermodal Money Transport System ‘Pay In’ transaction process flow.

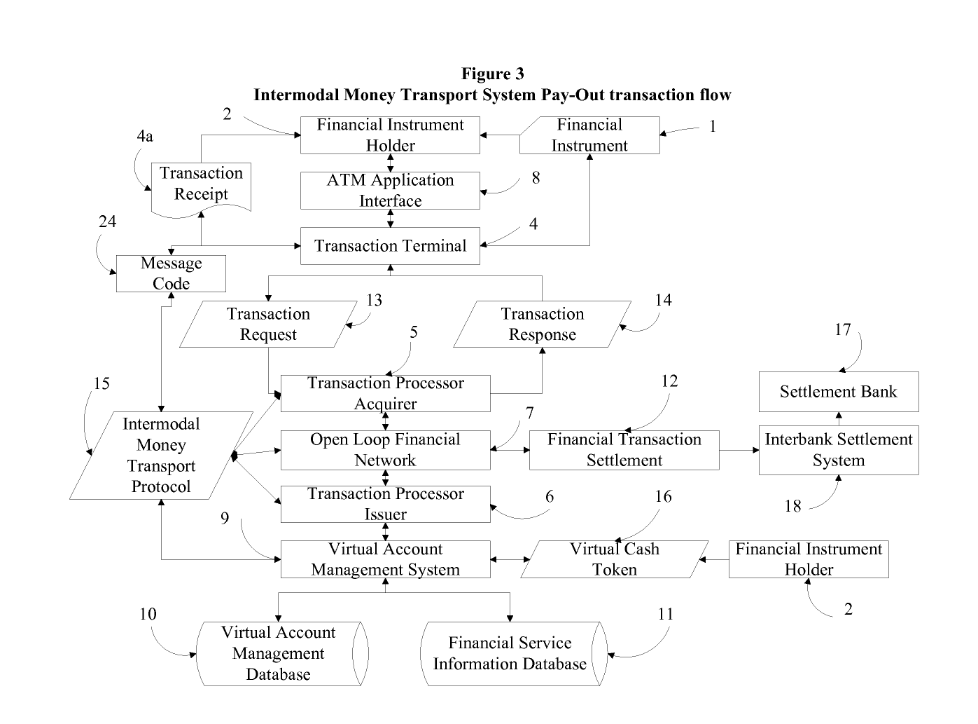

FIG. 3. Intermodal Money Transport System ‘Pay Out’ transaction process flow.

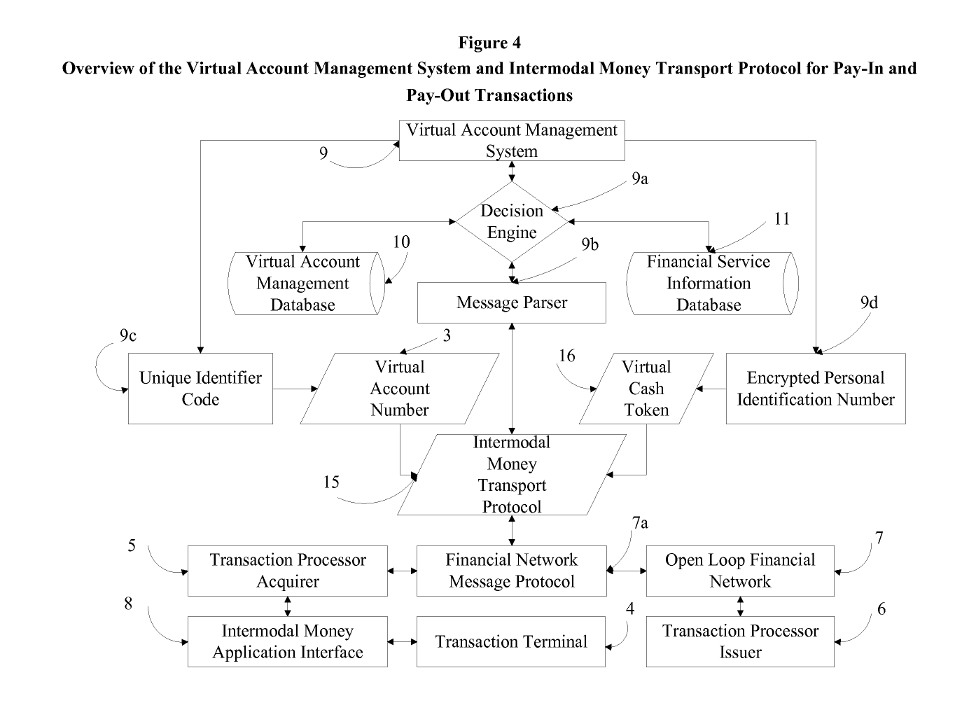

FIG. 4. Overview of the Virtual Account Management System transaction process flow.

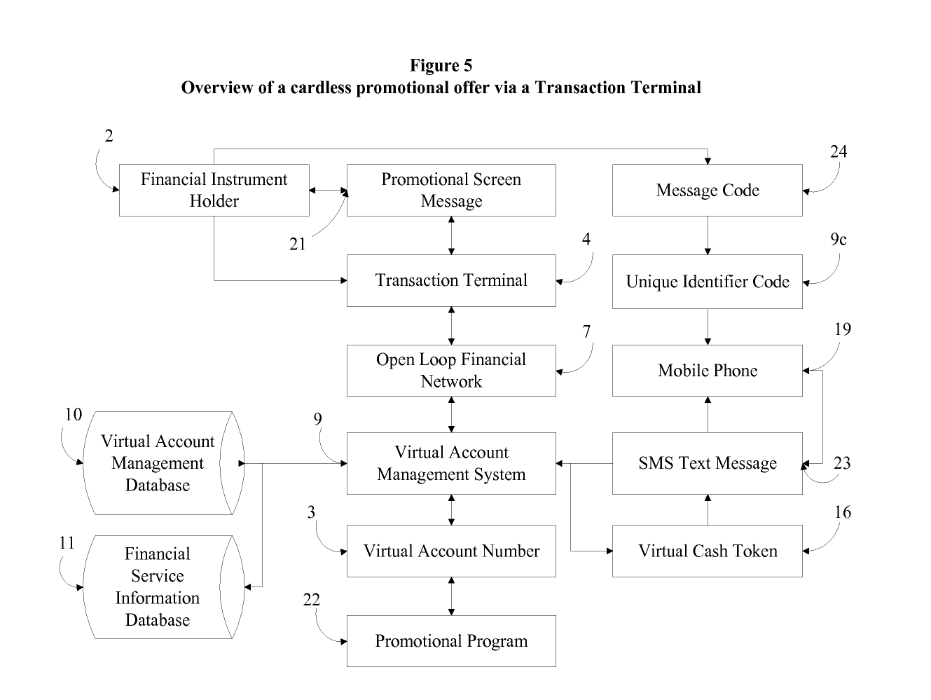

FIG. 5. Overview of a cardless promotional offer via a Transaction Terminal.

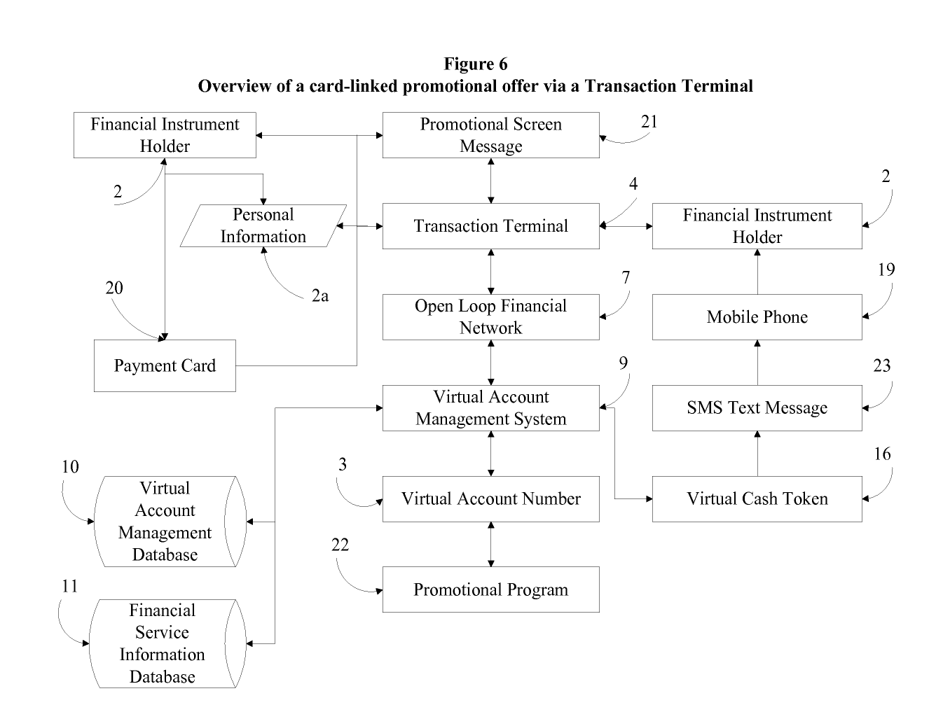

FIG. 6. Overview of a cardless promotional offer via a Transaction Terminal

### DETAILED DESCRIPTION

### FIGS. 1, 2, 3, 4—First Embodiment

Referring now descriptively to the drawings, the attached figures illustrate the first embodiment of the invention as a new and useful system and method for the execution of financial transactions over an Open Financial Network (7), through a Transaction Terminal (4), utilizing a Virtual Account Management System (9).

FIG. 1 illustrates the various operational domains utilized according to the present embodiment, the domain categories are:
1. Financial Instrument: Electronic Cash (e.g. Virtual Cash Token), Cash (e.g. Fiat Currency), Paper Check, ACH Debit or Credit, Credit Card, Debit Card, Virtual Currency (e.g. eMoney, Crypto Currency, or Asset-backed Currency), Real Time Gross Settle (e.g. Debit or Credit).
2. Financial Instrument Holder: A holder of a Financial Instrument and the legal owner or custodian of the Financial Instrument.
3. Virtual Account Number: A unique identifier of a temporary custodial account that is used solely for the purpose of executing a transaction or temporarily holding funds for a beneficiary.
4. Transaction Terminal: A programmable electronic device with the Intermodal Money Application Interface (8) setup the purpose of facilitating a financial transaction used to communicate a request and complete a transaction (e.g. POS terminal, ATM, Internet Computer, Smart Phone, Kiosk, etc.) utilizing the Intermodal Money Transport Protocol (15).
5. Transaction Processor Acquirer: An electronic funds transfer processor who manages the transaction requests and responses of the Transaction Terminal. Transaction processing includes various operational elements to complete a financial transaction request.
6. Transaction Processor Issuer: An electronic funds transfer processor who manages the transaction of the Financial Instrument (1). Transaction processing includes various operational elements to complete a financial transaction request.
7. Open Loop Financial Network: A financial network that provides connectivity between the Transaction Processor Acquirer and the Transaction Processor Issuer, and settles the transaction funds between the settlement accounts (e.g. Issuer, Acquirer) through the Interbank Settlement System.
8. Intermodal Money Application Interface: A software application that enables a programmable electronic device to function as an ATM that is connected to one or more open loop financial network systems.
9. Virtual Account Management System: An automated computerized management system that manages the transaction information, message protocols, and virtual accounts thus enabling Financial Instrument Holders to access the Open Loop Financial Network (7) during the course of a single session on the Transaction Terminal (4) and to pass the data between the Financial Instrument Holder (2) and the transaction processors (e.g. Issuer, Acquirer) utilizing the Intermodal Money Transport Protocol (15).
10. Virtual Account Management Database: A computerized database system that stores and manages virtual account and personal information.
11. Financial Service Information Database: A computerized database system that stores and manages financial service information.
12. Financial Transaction Settlement: The Open Loop Financial Network (7) process for clearing and settling the Financial Instrument (1) which depending on the Interbank Settlement System (18) that is used, may or may not be cleared and settled in real-time.
13. Transaction Request: A message protocol for requesting a transaction from the Transaction Terminal (4) through the Transaction Processor Acquirer (5) to the Transaction Processor Issuer (6) via the Open Loop Financial Network (7).
14. Transaction Response: A message protocol for authorization or denial of a Transaction Request (13) to the Transaction Terminal (4) through the Transaction Processor Acquirer (5) from the Transaction Processor Issuer (6) via the Open Loop Financial Network (7).
15. Intermodal Money Transport Protocol: A message data set that transmits the transaction information through the Open Loop Financial Network (7) to and from the Transaction Terminal (4) via the Transaction Processor Acquirer (5) and Transaction Processor Issuer (6).
16. Virtual Cash Token: Electronically tokenized funds comprising; a Virtual Account Number (3), Virtual Account Management System (9) generated Encrypted Personal Identification Number (9d) (“PIN”), the transaction amount, and a combination of personal and financial service information that are transported via the Open Loop Financial Network (7) in real-time and are readily convertible to cash or available in a cash equivalent to the Financial Instrument Holder (2) through a Transaction Terminal (4).
17. Settlement Bank: A depository financial institution that is an Open Loop Financial Network (7) member and settles interbank transactions.
18. Interbank Settlement System: The clearing and settlement of funds between depository institutions and the private sector, normally a central bank. In the United States it operates through the privately owned Clearing House Interbank Payments System (CHIPS) or by the Federal Reserve Banks' Fed Wire or National Settlement Service (NSS) for high value real time gross settlements (RTGS), and the Automated Clearing House system for batch debit and credit clearing and settlement operated by the Federal Reserve Banks and the Electronic Payments Network (EPN), the only private-sector ACH operator in the U.S.
19. Mobile Phone: A mobile computing device that is linked to a unique telephone number and capable of receiving mobile messages such as SMS text messages and other forms of electronic medium that can be stored in its memory.
20. Payment Card: A card issued by a financial institution that is linked to one or more open loop financial networks.
21. Promotional Screen Message: A promotional message that is displayed on a Transaction Terminal (4) prompting the Financial Instrument Holder (2) to take a call to action or the like related to a Promotional Program (22).
22. Promotional Program: An advertising or marketing program that is linked in to the Financial Instrument Holder (2) in the Virtual Account Management System (9).
23. SMS Text Message: A Short Message Service is a text messaging service component of phone, web, or mobile communication systems. It uses standardized communications protocols to allow fixed line or mobile phone devices to exchange short text messages.
24. Message Code: An alphanumeric code that identifies communications link via a communications network.

FIG. 2 illustrates the Intermodal Money Transport System ‘Pay In’ transaction flow.

A ‘Sender’ Financial Instrument Holder (2) initiates a ‘Pay In’ transaction with a Financial Instrument (1) using the Intermodal Money Application Interface (8) on the Transaction Terminal (4) that sends a Transaction Request (13) utilizing the Intermodal Money Transport Protocol (15) with the required transaction information through the Transaction Processor Acquirer (5) who manages the transaction message cycle, and routes the transaction through the Open Loop Financial Network (7) to the Transaction Processor Issuer (6). The Virtual Account Management System (9) checks the Virtual Account Management Database (10) validates and authenticates identity of the ‘Sender’ and the Transaction Processor Issuer (6) transaction authorization, collects the necessary data from the Financial Service Information Database (11) with the requested financial service transaction information, the Virtual Cash Token (16) is created, all of the stored data is updated to reflect the authorized transaction, the Transaction Response (14) is sent to the Transaction Processor Acquirer (5), through the Open Loop Financial Network (7) utilizing the Intermodal Money Transport Protocol (15), and transmits the Message Code (24) to the Transaction Terminal (4) for a receipt record of the transaction for the ‘Sender’, an electronic notification of transaction is sent to the ‘Receiver’ with the Virtual Cash Token (16), the Financial Transaction Settlement (12) is initiated through the Open Loop Financial Network (7), the transaction amount clears and settles to Settlement Bank (17) through Interbank Settlement System (18).

FIG. 3 illustrates the Intermodal Money Transport System ‘Pay Out’ transaction flow.

After receiving the Virtual Cash Token (16) from the Financial Instrument Holder (2) through the Virtual Account Management System (9), the ‘Receiver’ Financial Instrument Holder (2) initiates a ‘Pay Out’ transaction using the Intermodal Money Application Interface (8) on the Transaction Terminal (4) which sends a Transaction Request (13) utilizing the Intermodal Money Transport Protocol (15) with the required transaction information through the Transaction Processor Acquirer (5) who manages the transaction message cycle, and routes the transaction through the Open Loop Financial Network (7) to the Transaction Processor Issuer (6). The Virtual Account Management System (9) collects the necessary data from the Virtual Account Management Database (10), and the Financial Service Information Database (11) and authenticates the Virtual Cash Token (16) with the requested financial service transaction information, and if the transaction is authorized, all of the stored data is updated to reflect the authorized transaction, the Transaction Response (14) is sent utilizing the Intermodal Money Transport Protocol (15) through the Open Loop Financial Network (7) to the Transaction Processor Acquirer (5) who issues the Financial Instrument (1) and transmits the Message Code (24) to the ‘Receiver’ through the Transaction Terminal (4), provides a receipt record of the transaction to the ‘Receiver’ Financial Instruments Holder (2), and initiates the Financial Transaction Settlement (12) through the Open Loop Financial Network (7) and the transaction amount clears and settles to Settlement Bank (17) through Interbank Settlement System (18).

FIG. 4 illustrates how the Intermodal Money Transport System utilizes the Virtual Account Management System and the Intermodal Money Transport Protocol for Pay In and Pay Out transactions.

The Intermodal Money Application Interface (8) transmits a message from Transaction Terminal (4) through the Transaction Processor Acquirer (5) to the Transaction Processor Issuer (6) that is compatible with the Financial Network Message Protocol (7a) utilizing the Intermodal Money Transport Protocol (15) and the Virtual Cash Token (16) comprising; a combination of the Virtual Account Number (3) with the Unique Identifier Code (9c), Virtual Account Management System (9) generated Encrypted Personal Identification Number (9d) and the transaction amount, and processed by the Virtual Account Management System (9) through the Message Parser (9b) and the rules based Decision Engine (9a) by utilizing personal information in the Virtual Account Management Database (10) and financial services information in the Financial Services Information Database (11) to validate and authorize a Pay-In and Pay-Out transactions through the Open Loop Financial Network (7).

FIG. 5 illustrates how the Transaction Terminal offers the Financial Instrument Holder a Promotional Program in a cardless transaction utilizing the Virtual Account Management System over the Open Loop Financial Network.

The Financial Instrument Holder (2) initiates the cardless transaction on the Transaction Terminal (4) and is prompted by the Promotional Screen Message (21) that displays the Message Code (24) the Financial Instrument Holder (2) enters the Message Code (24) and the Unique Identifier Code (9c) into the Mobile Phone (19) and sends the SMS Text Message (23) to the Virtual Account Management System (9) which uses the Unique Identifier Code (9c) to link the Financial Instrument Holder's (2) Virtual Account Number (3) with the Promotional Program (22), and updates the Virtual Account Management Database (10) and the Financial Service Information Database (11), and creates the Virtual Cash Token (16), and sends it via the SMS Text Message (23) to the Mobile Phone (19) and used by the Financial Instrument Holder (2) at the Transaction Terminal (4) to complete the transaction through the Open Loop Financial Network (7), or is stored the Mobile Phone (19) memory to be redeemed at a later time at the Transaction Terminal (4) or any other Transaction Terminal connected to the Open Loop Financial Network (7).

FIG. 6 illustrates how the Transaction Terminal offers the Financial Instrument Holder a card-linked Promotional Program in a Payment Card transaction utilizing the Virtual Account the Management System over the Open Loop Financial Network.

The Financial Instrument Holder (2) initiates the Payment Card (20) transaction on the Transaction Terminal (4) which displays the card-linked Promotional Screen Message (21) that prompts the Financial Instrument Holder (2) to enter Personal Information (2a) including the Mobile Phone (19) number, and the Transaction Terminal (4) sends the Personal Information (2a) Mobile Phone (19) number, and the Payment Card (20) data Open Loop Financial Network (7) to the Virtual Account Management System (9) which creates a Virtual Account Number (3) that links Financial Instrument Holder's (3) Payment Card (20) data and Personal Information (2a) with the card-linked Promotional Program (22), and updates the Virtual Account Management Database (10) and the Financial Service Information Database (11), and creates the Virtual Cash Token (16), and sends it via the SMS Text Message (23) to the Mobile Phone (19) used by the Financial Instrument Holder (2) at the Transaction Terminal (4) to complete the transaction through the Open Loop Financial Network (7), or is stored the Mobile Phone (19) memory to be redeemed at a later time at the Transaction Terminal (4) or any other Transaction Terminal (4) connected to the Open Loop Financial Network (7).

### CONCLUSION, RAMIFICATIONS, and SCOPE

In conclusion the reader will see that the present embodiment of the invention provides a more reliable and more useful system and method to send and receive money in real-time on a Transaction Terminal (4) by utilizing the Intermodal Money Transport Protocol (15) and Virtual Account Management System (9) that converts any financial instrument into a Virtual Cash Token (16) that is readily convertible into cash or a cash equivalent exists in the prior art. While the above description contains numerous specificities, these should not be construed as limitations on the scope, but rather as an exemplification of one embodiment thereof. Many other variations are possible.

Furthermore any ramifications that may arise from one or more elements being eliminated or duplicated, connected or associated with each other in a different manner, given a different mode or function of operation and/or made integrally or separately that may arise from future technological innovations or modifications in the financial networks' or electronic devices' communications specification protocols does not materially invalidate the claims made herein.

Accordingly, the scope should be determined not by the embodiment illustrated, but the appended claims and their legal equivalents. It is further intended that any other embodiments of the present invention that result from any changes in application or method of use or operation, or design which are not specified within the detailed written description or illustrations contained herein yet are considered apparent or obvious to one skilled in the art are within the scope of the present invention.

### GLOSSARY OF TERMS

1. Acquirer: A transaction acquiring counter party and the electronic funds transfer data processing host that acquires the transaction from a transaction terminal (e.g. ATM, POS, etc.) and handles the transaction through an open-loop financial network.
2. ATM Application Interface: A software application that enables a programmable electronic device to function as an ATM that is connected to one or more open-loop financial networks.
3. Closed-loop Financial Networks: A financial network where a single entity such as a merchant, a financial institution, or a non-bank financial services intermediary is both the transaction issuer and acquirer.
4. Financial Instrument: Electronic money (e.g. Virtual Cash Token), cash (e.g. fiat currency), paper check, ACH debit or credit, credit card, debit card, virtual currency (e.g. eMoney, Crypto-currency, or Asset-backed-currency).
5. Financial Instrument Holder: An individual that possesses the means of effecting a payment at a transaction terminal in a ‘Pay In’ transaction or conversely receives a payment at a transaction terminal on a ‘Pay Out’ transaction.
6. Financial Network Settlement: The settlement of funds that are paid and received by the relevant parties to the transaction.
7. Financial Service Information Database: A computerized database system that stores and manages financial service information.
8. Issuer: The transaction issuing counter party and electronic funds transfer data processor that authorizes or declines the transaction request of a financial Instrument holder through an open-loop financial network.
9. Merchant Account: An account that is owned by any merchant that owns and/or operates electronic terminals such as ATM and POS systems.
10. Open-Loop Financial Network: A financial network that provides connectivity between the transaction processor acquirer(s) and the transaction processor issuer(s), and settles the transaction funds between settlement banks (e.g. Issuer, Acquirer) through an interbank settlement system for multiple financial institutions.
11. Operating Account: An account that can accept deposits held at depository institutions including bank accounts and stored value accounts.
12. Pay In: A payment event in which a financial instrument holder effects a payment to a third party through a transaction terminal.
13. Pay Out: A payment event in which a beneficiary receives a payment from a transaction-originating sender on a Transaction Terminal.
14. Non-Bank Financial Service Provider: Any party providing a financial service that is not a depository institution.
15. Settlement Account: A custodial account held at depository institutions solely for the purpose of facilitating the settlement of funds between the counter parties in a transaction.
16. Transaction Processor: An electronic funds transfer (EFT) data processing system that includes various operational elements to complete a financial transaction.
17. Transaction Request: A transaction request through an electronic funds transfer processing switch for an authorization or declined transaction response.
18. Transaction Response: A transaction response through an electronic funds transfer-processing switch to authorize or decline a transaction request.
19. Transaction Terminal: A programmable electronic device (e.g. POS terminal, ATM, Internet Computer, Smart Phone, Kiosk, etc.) used for the purpose of facilitating a financial transaction that communicates a request and receives a response to complete a transaction.
20. Virtual Account: A temporary custodial account that is used solely for the purpose of executing a transaction.
21. Virtual Account Management Database: A computerized database system that stores and manages the virtual account information.
22. Virtual Account Management System: An automated computerized management system that manages the transaction information, message protocols, and virtual accounts enabling financial instrument holders to access open-loop financial networks during the course of a single session on a transaction terminal.
23. Virtual Account Number: A unique identifier that is generated by the Virtual Account Management System to validate and authenticate the financial network transaction.
25. Virtual Cash Token: An electronic cash equivalent in the form of a alpha numeric code generated by the Virtual Account Management System that electronically tokenizes funds comprising; a Virtual Account Number, Virtual Account Management System generated Encrypted Personal Identification Number (“PIN”), the transaction amount, and a combination of personal and financial service information that are transported via the Open Loop Financial Network (in real-time and are readily convertible to cash or available in a cash equivalent to the validates the Financial Instrument transaction and authenticates the Financial Instrument Holder.

I claim:

1. A method for sending and receiving cash or a cash equivalent in real-time on an electronic device over one or more open loop financial networks, from a temporary source account, that is not controlled by the sender as the originator of the transaction, to a temporary destination account that is controlled by the receiver as the beneficiary of the transaction, utilizing a virtual account management system and an intermodal money transport protocol where the transactions are processed as ATM withdrawals and deposits or as any other transaction that can be performed on a self-service payment terminal comprising a plurality of elements.

2. A method of claim 1 utilizing a virtual account management system and an intermodal money transport protocol comprising a plurality of elements comprising;
a) utilizing an account number comprising; an issuer identification number and a mobile phone number, voucher number or the like;
b) utilizing a virtual account management system generated encrypted personal identification number;
c) providing the amount sent by the originator of the transaction and to be received by the beneficiary of the transaction;
d) utilizing said intermodal money transport protocol and a virtual cash token comprising; said virtual account number, said personal identification number and the transaction amount, and a combination of personal and financial service information;
e) utilizing transaction terminals, open loop financial networks, transaction processing systems and financial services processing systems;
f) utilizing virtual accounts, depository accounts, and settlement accounts for settlement of funds;
g) providing a combination of said personal sender and receiver information, and virtual cash tokens for effecting the transaction and a proportional message;
h) providing real-time validation of funds availability for transaction clearing and settlement;
i) providing notification to the sender and receiver that the funds have been transferred;
j) providing real-time funds clearing and posting for immediate access to cash or a cash equivalent in a single session on said transaction terminal;
k) not requiring the sender or receiver of funds to disclose card or bank account information;
l) providing access to said open loop financial network processing systems effecting the execution of said real-time cash or cash equivalent transactions for non-bank financial service providers;
m) effecting financial transactions as requested by an individual financial instrument holder;
n) utilizing a data set comprising; an issuer identification number, a mobile phone number, a personal identification number, and a transaction amount, for the validation and authorization of said individual financial instrument holder's transaction request;
o) utilizing a data set that requires no modification of financial network messaging protocols, where send and receive funds transactions are processed as ATM withdrawals and deposits.

3. A method of claim 1 comprising a virtual account management system utilizing an intermodal money transport protocol and a virtual cash token for the integration and generation of a data set message that is independent of the modality of payment method used in processing the transaction of the financial instrument by the electronic funds transfer system.

4. A method of claim 3 comprising of a process for tracking the pay-in and pay-out cycle of open loop financial network transactions.

5. A method of claim 1 comprising a computer programmable electronic device that functions as a transaction terminal, utilizing a data set message that is independent of the modality of payment method used in processing the transaction of the financial instrument by the electronic funds transfer system.

6. A method of claim 1 comprising where the value of the open loop financial network transaction is fixed by the intermodal money transport protocol at the point of origination and the authorized transaction is irreversible by the sender as the originator of the transaction.

7. A method of claim 6 further comprising the transaction settlement comprising;
a) providing a virtual account management system for the clearing and settlement of an open loop financial network cash or a cash equivalent transaction where said financial transaction is settled by said open loop financial network through the interbank settlement system;
b) providing a method for said financial transaction to be cleared and settled through said open loop financial network utilizing a settlement bank and interbank settlement system.

8. A method of claim 6 for settling said open loop financial network transaction further comprising:
a) utilizing various accounts as required for transaction settlement including funding accounts, operating accounts, settlement accounts and merchant accounts;
b) utilizing various accounts as required for the auditing, recording, reporting and settlement data of the individual transaction utilizing a virtual cash token, whereby an individual's request for said open loop financial network transaction is audited, recorded and reported on when the transaction is completed.

9. A method as in claim 6 for settling open loop financial network transaction comprising; the authorization and settlement process of said open loop financial network transaction between the originator of the transaction the acquiring processor of the transaction and a settlement account.

10. The method of claim 1, further comprising: displaying, on a display device of said mobile device, a promotional message, said promotional message based on at least one of (i) an identity of an operator of the transaction terminal, (ii) a location of the transaction terminal, (iii) a profile of the customer, and (iv) the transaction accounts used by the customer.

11. A method and system enabling a computer programmable electronic device to function as automated teller machine utilizing a plurality of elements to send and receive cash or a cash equivalent in real-time over open loop financial networks.

12. A method of claim 11 a computer programmable electronic device to function as automated teller machine utilizing a plurality of elements comprising;
a) utilizing an executable intermodal money application interface software program;
b) utilizing an intermodal money transport protocol data set;
c) utilizing a communications message protocols and connectivity to the acquiring transaction processor;
d) recording and forwarding a transaction request to the acquiring transaction processor from the transaction originator;
e) receiving and recording a transaction response from the acquiring transaction processor;
f) providing a receipt record of the transaction to the transaction originator;
g) communicating the transaction response to the transaction beneficiary;
h) providing cash or a cash equivalent to the transaction beneficiary for an authorized transaction;
i) providing a receipt record of the transaction to the receiver as the beneficiary of the transaction.

13. A method of claim 11 further comprising a unique data set comprised of a plurality of instructions for connectivity to the open loop financial networks, where send and receive funds transactions are processed as ATM cash withdrawals and deposits.

14. A method of claim 13 for handling of the acquiring transaction processor request and response for a universal pay-in and pay-out transaction through open loop financial networks in a real-time cash or cash equivalent payment environment on a transaction terminal.

15. A method of claim 11 of a transaction terminal interface comprising;
a) providing a message protocol integrated into the transaction terminal interface for transmission to and from the acquiring transaction processor;
b) providing an transaction terminal interface enabling a financial service provider to offer ‘pay-in’ and ‘pay-out’ real-time cash or a cash equivalent transaction to a financial instrument holder;
c) providing an transaction terminal interface enabling a financial service provider to offer an open loop financial transaction to a financial instrument holder;
d) providing an transaction terminal interface that enables the entry and execution of a transaction request in a single acquiring session resulting in real-time open loop financial network transaction, where the value of the transaction is fixed by the intermodal money transport protocol at the point of origination and the authorized transaction is irreversible by the sender as the originator of the transaction.

16. A method of claim 11, further comprising; displaying on a transaction terminal with said transaction terminal interface, a promotional message, said promotional message based on at least one of (i) an identity of an operator of the transaction terminal, (ii) a location of the transaction terminal, (iii) a profile of the customer, and (iv) the transaction accounts used by the customer.

17. A method of claim 11, further comprising; displaying on a transaction terminal with said ATM interface a promotional message, after a payment card holder has completed an open loop financial network transaction by swiping of dipping the card on said transaction terminal, to opt-in or opt-out of a card-linked promotional offer and prompting the cardholder, and after selecting the opt-in function, to enter their mobile phone number and any additional information such as the card expiration date, cardholder's postal code or any other information that may be required by the card-linked program, and transmitting the entered information and card data to a virtual account management system through an open loop financial network and said virtual account management system creates a card-link program virtual account for said cardholder,

18. A method of claim 17 whereby the card-link program virtual account holder receives a virtual cash token sent to said mobile phone number in the form of an SMS text message or in another form of electronic online medium displayed on a mobile device screen, that can be redeemed at said transaction terminal or on a different transaction terminal at another location connected to one or more open loop networks.
